(19) United States
(12) Patent Application Publication
(10) Pub. No.: US 2023/0151539 A1
(43) Pub. Date: May 18, 2023

(54) COATED AND VARNISHED MEMBRANE COMPRISING SILVER, METHOD FOR THE PRODUCTION THEREOF AND USE THEREOF AS A VIRUCIDE

(71) Applicant: SERGE FERRARI SAS, SAINT JEAN DE SOUDAIN (FR)

(72) Inventors: Jonathan ROJON, GLATTFELDEN (CH); Valérie COURAULT, RUY MONTCEAU (FR); Annie ANDRIEU, SAINT BONNET DE MURE (FR); David GUITTON, WÜRENLO (CH); Philippe ESPIARD, GOUVIEUX (FR)

(21) Appl. No.: 17/920,563

(22) PCT Filed: Apr. 23, 2021
(86) PCT No.: PCT/FR2021/050715

§ 371 Date: Oct. 21, 2022

(30) Foreign Application Priority Data
Apr. 24, 2020 (FR) 2004133

(51) Int. Cl. D06N 3/06; D06N 3/00; D06N 3/18

(52) U.S. Cl. CPC D06N 3/06; D06N 3/0063; D06N 3/183; D06N 2205/023; D06N 2205/103; D06N 2209/1671

(57) ABSTRACT

A coated and varnished membrane, the membrane including at least one fabric having at least one side coated with at least one layer of polyvinyl chloride, and at least one varnish film on the coated side of the membrane, the varnish film including a polymeric binder and silver in the form of a silver element less than 250 nm in size. A process for manufacturing a membrane according to the invention. A use of a membrane as a virucide.

### FIELD OF THE INVENTION

The invention relates to the field of coated membranes, more specifically coated fabrics typically usable as protective tarpaulins.

The invention relates more particularly to a new membrane structure which has both good resistance to abrasion, good ability to be assembled by a standard welding process, good fire resistance and antiviral action. Such a membrane can also be cleaned with commonly used antiseptics. It can be used in the medical field or for sanitary purposes.

### BACKGROUND OF THE INVENTION

In the field of coated membranes, textiles coated with a material made from polyvinyl chloride (or PVC), typically flame-retardant plasticized PVC, are very commonly used. These PVC-coated textiles have the advantage of being easily assembled by heat-welding, which allows manufacturing adapted to the shape to be produced while preserving the waterproofness of the membrane.

On the other hand, silver, for example in the form of particles of nanometric size (or nanoparticles), is used in the medical field mainly for its antibacterial effects. To date, silver nanoparticles are used in dressings where they have been incorporated by impregnation, or are dispersed in polymers molded into blocks constituting all or part of medical devices such as, for example, catheters or orthopedic implants, particularly in order to limit the formation of pathogenic biofilm. Finally, textiles such as surgical drapes or surgical masks may also contain silver nanoparticles, incorporated by impregnation and present within the material. However, these textile articles are not waterproof or heat-weldable. In these different applications, silver is incorporated mainly by impregnation or extrusion.

Silver is also known for applications outside the medical field. For example, incorporated into shoes or clothing (socks, t-shirts, hoods, etc.), silver nanoparticles make it possible to fight against bacteria that cause bad odors and also prevent fungal infections. In this case, they are incorporated by extrusion during spinning or by impregnation during the finishing of the textile. Integrated into washing machines, the silver nanoparticles release Ag⁺ ions during the washing cycle, which allows the laundry to be more thoroughly sanitized.

Thus, silver is commonly used for its bactericidal properties. Now, it was recently observed that silver also has antiviral properties (Thesis No. 120, R. Chauvet, “Applications of silver nanoparticles in therapy”, October 2018, University C. Bernard Lyon 1—Faculty of Pharmacy and Institute of Pharmaceutical and Biological Sciences). The antiviral activity of silver is in the early stages of research.

Indeed, bacteria and viruses are different entities, whether by size (viruses are on average about a thousand times smaller in size than bacteria, which have a minimum size of about 1 μm), by structure (the virus is considered a biological entity and the bacterium is a living organism), or by genetic material (bacteria are prokaryotes with DNA and RNA; viruses have only one of these acids).

Patent application CN 108894005 discloses an antibacterial artificial leather using polyvinyl chloride (PVC) made from a base fabric, which may be a cloth, an intermediate layer bonded to the fabric layer by an adhesive layer, with a surface PVC layer and a protection layer against the environment. The protection layer against the environment plays a role of varnish and comprises water-based polyurethane and an antibacterial agent including an organic antibacterial component composed of nanoscale particles, which is preferably nano chitosan, and an inorganic antibacterial component including nanoscale particles. The inorganic antibacterial component may be nano silver, nano zinc, nano copper, or nano titanium or their oxides. The protection layer against the environment is made from an aqueous, non-solvent medium. The antibacterial agent must include an organic component and an inorganic component in order to obtain the desired antibacterial effect (as demonstrated in Comparative Examples 2 and 3).

At the present time, there are no surface-coated textiles comprising antiviral properties while retaining weldability properties and resistance to abrasion and washing (cleanability), which can be used in the medical field or for sanitary purposes, such as for modular sanitary structures, tents, partition walls in hospitals, stretchers, or even mattress covers or any other membrane that may be useful in the vicinity of patients.

Currently, there is a need for such a material in order to limit the spread of viruses and, therefore, an epidemic or even a pandemic.

For that reason, the aim of the invention is to propose a coated membrane having an antiviral action, as well as a process for manufacturing such a membrane.

### SUMMARY OF THE INVENTION

According to a first aspect, the invention relates to a coated and varnished membrane, said membrane comprising at least one fabric having at least one side coated with at least one layer of polyvinyl chloride, and at least one varnish film on said coated side of the membrane, said varnish film comprising a polymeric binder and silver in the form of a silver element less than 250 nm in size, said membrane being such that the varnish film has an average thickness in the range of 0.5 to 20 μm and that the silver mass content in the varnish film is in the range of 0.00001 to 3%.

According to the invention, the coated side of the fabric may be coated with at least one layer of polymer, for example a layer of polyurethane or a layer of PVC, then with the layer of polyvinyl. chloride. Therefore, the polyvinyl chloride layer is an outer layer (i.e., the furthest from the fabric) on which the varnish film rests, itself in contact with the outside (relative to the fabric).

One or more layers of polymer(s) may be deposited on each side of the membrane without one side being necessarily coated with the same number of layers, and layers of the same nature and thickness, as the corresponding other side.

According to the invention, the expression “silver element less than 250 nm in size” is understood to mean a silver atom (elementary), or a silver nanoparticle less than 250 nm in size, preferably in the range of 1 to 250 nm. Thus, the particle size is generally qualified as nanometric.

According to the invention, the term “size” is understood to mean the largest dimension of the particle. Obviously, a silver atom meets the size criterion of less than 250 nm.

Preferably, the silver nanoparticles are less than 150 nm in size, preferably in the range of 1 to 150 nm. Even more preferably, the silver nanoparticles are less than 100 nm in size, preferably in the range of 1 to 100 nm.

Advantageously, according to the invention, the silver is in the form of silver atoms (originated from silver ions solubilized in the varnish before deposition of the varnish film), or particles of nanometric size which can reach 250 nm of silver (originated from silver nanoparticles dispersed in the varnish before deposition of the varnish film). This reduced size advantageously allows maximum efficacy of the antiviral function given the very large surface availability that it induces and the nanometric size of the viruses.

According to one embodiment of the invention, the mass content of silver in the varnish film is preferably in the range of 0.0005 to 2%, even more preferably 0.001 to 1%. This content is expressed in relation to the silver element and calculated once the film has dried.

The membrane according to the invention is most often available as a strip of suitable length, typically 50 m, and up to 5 m wide. Thus, this membrane is easily rollable or foldable, and transportable, which facilitates possible handling and logistics operations.

Unexpectedly, the silver particles present in the varnish confer antiviral activity on the coated and varnished membrane, while maintaining its usual properties, i.e., resistance to cleaning by most antiseptics used in sanitary and/or medical fields, as well as abrasion resistance. Thus, such a membrane has a valuable service time. Another of the advantages of the invention is that the coated and varnished membrane can be easily welded, typically by heat-welding, to another membrane, generally coated and varnished, without losing its antiviral action. This allows a modular assembly of the membranes according to the invention based on the needs of the end user, which is particularly valuable.

Thus, the membrane according to the invention makes it possible to limit, or even stop the proliferation of viruses in the environments used or inhabited by humans, by an antiviral action which kills viruses by surface contact, in the absence of any human cleaning intervention, in just a few minutes of contact.

According to the invention, the term “fabric” is understood to mean a textile material. The fabric constitutes the core or reinforcement of the coated and varnished membrane.

Preferably, the fabric is selected from wovens, nonwovens, grids, knits, and mixtures thereof, preferably from wovens and nonwovens.

According to one embodiment of the invention, the fabric is made from textile material and comprises yarns or fibers made from a material selected from the group comprising glass, polyesters including aromatic polyesters (such as, for example, the commercial product Vectran® from Kuraray), polyamides including aromatic polyamides (such as, for example, the commercial product Kevlar® from Dupont), polyacrylates, viscoses, nylons, cottons, polyvinyl acetates, polyvinyl alcohols, and mixtures thereof. Preferably, the fabric is a woven or on-wove polyester, typically high tenacity polyester.

According to a preferred embodiment of the invention, the layer of polyvinyl chloride comprises polyvinyl chloride, at least one plasticizer and at least one heat stabilizer. The plasticizer is generally in the range of 30 to 100 parts by weight based on 100 parts by weight of PVC. The heat stabilizer is generally in the range of 0.5 to 10 parts by weight based on 100 parts by weight of PVC.

The polyvinyl chloride layer is generally deposited on the fabric or on the fabric previously coated with at least one layer of polymer, such as a layer of polyurethane or PVC, by a coating step using a paste with which the membrane is coated, in a manner known to a person skilled in the art. Usually, PVC resin in powder form (obtained from emulsion or micro-suspension polymerization of the vinyl chloride monomer) is dispersed in a liquid plasticizer, which gives the paste called plastisol. However, it may also be deposited by extrusion or calendering.

The PVC layer may also contain at least one additive such as a pigment, for example a nickel titanate, or a titanium dioxide; at least one flame retardant filler such as antimony trioxide, alumina trihydrate, zinc borate or calcium carbonate; a fungicide and/or any other additive known to a person skilled in the art.

According to the invention, it is particularly preferred that the membrane not contain any other antibacterial compound than silver (which can play this role in addition to its antiviral action). It is even more particularly preferred that the membrane not contain any organic antibacterial compound. It is particularly excluded that the membrane contains chitosan, in any form whatsoever.

As is common practice, the plasticizer is selected by a person skilled in the art according to the applications and properties required for the membrane. It is generally of the ester type, typically selected from phthalates, phosphates and adipates. For example, if cold hardiness is required, an adipate-type plasticizer such as dicotyl adipate (DOA) is typically used. There are many commercial plasticizers such as diisononyl phthalate (DINP), available from BASF and Exxon, for example, but also diisodecyl phthalate (DIDP), dioctylterephthalate (DOTP), di(2-propylheptyl) phthalate (DPHP), 1,2-cyclohexane dicarboxylic acid (DINCH), 2-ethylhexyl diphenyl phosphate (Santicizer® 141 from Valtris), tris(2-ethylhexyl) trimellitate (TOTM) or a biobased plasticizer such as Polysorb® ID37 from Roquette.

Usually, the thermal stabilizer, which is added to the plastisol, is a metallic salt such as a barium and zinc salt, or a calcium and zinc salt, or a tin-based compound. However, the thermal stabilizer may also be an organic compound. It makes it possible to gel the plastisol at a temperature typically between 140° C. and 200° C. without degrading the PVC.

A standard plastisol formula that may be used according to the invention is the following, given in parts by weight:
PVC resin: Lacovyl® PB1302 from Kem One: 100
Plasticizer: Jayflex® DINP from Exxon: between 50 and 100, for example 60
Thermal stabilizer: made from barium and zinc salts: Mark® 962 from Galata: between 1 and 5, for example 3
Pigment: Kronos® 2220 titanium dioxide from Kronos: between 0 (excluded) and 40, for example 7
Flame-retardant filler: Blue Star MT® antimony trioxide from Campine: between 0 (excluded) and 60, for example 10.

According to one embodiment of the invention, the varnish film has an average thickness preferably in the range of 1 to 12 μm, even more preferably 2 to 10 μm. For example, the average thickness is between 4 and 8 μm. The appearance of the outer surface of the film follows the appearance of the PVC layer before the film is deposited and is therefore not completely smooth.

In addition, the thickness may vary from one point to another of the film, typically by ±3 μm.

Advantageously, the varnish film is transparent.

According to one embodiment, the polymeric binder is selected from the group comprising polyester polyurethanes, polyether polyurethanes, polycarbonate polyurethanes, silicone-modified polyurethanes, acrylics, acrylates, acrylate copolymers, acrylic copolymers, acrylic styrenes, ethylene vinyl acetates, and mixtures thereof.

Polyurethanes are a class of polymers whose composition and structure can be highly variable, thanks to the reagents used to synthesize them. They are obtained by the polyaddition reaction of polyols and polyisocyanates. The molar mass of the final polymer will depend on the stoichiometric conditions of the OH (alcohol) and NCO (isocyanate) functions and the progress of the reaction. The synthesis is carried out by incorporating an emulsifier, most often internal (integrated into the polymer chain), very often of a hydrophilic nature in order to make it possible to stabilize the polymer in water. Three hydrophilic groups are mainly used:
Anionic groups (ionized carboxylic or sulfonic group)
Cationic groups (protonated tertiary amine)
Nonionic groups (poly(oxyethylene)-type chain

In the first two cases, the synthesis is carried out by adding at least one emulsifier. In the third case, the synthesis is carried out by adding segments of water-soluble polymers.

The varnish film may be transparent or colored, typically by adding at least one pigment to the varnish. The pigment is, for example, selected from the group comprising titanium dioxide (white), carbon black, phthalocyanine, and mixtures thereof. Particularly preferably, the pigment does not comprise a sulfur atom.

According to a second aspect, the invention relates to a process for manufacturing a membrane according to the invention, comprising the following steps:
(a) providing a coated membrane comprising at least one fabric comprising at least one side coated with at least one layer of polyvinyl chloride;
(b) providing a varnish comprising an aqueous medium, at least one polymeric binder, and silver;
(c) depositing on the coated side from step (a) a varnish film from step (b), to a thickness in the range of 0.5 to 20 μm; and
(d) drying the varnish film from step (c), leading to the production of the coated and varnished membrane.

Thus, this is referred to as a water-based deposition of varnish.

According to one embodiment, the process comprises an additional step, subsequent to step (d), of calendering the coated and varnished membrane obtained in step (d).

According to the invention, the term “varnish” is understood to mean a liquid, colored or not, which has the ability to form a film after being applied to a substrate and drying. The polymeric binder, which comprises at least one organic synthetic compound, is one of the essential components of the varnish.

According to the invention, the term “aqueous medium” is understood to mean a liquid phase generally comprising several chemical species, in which water is the major constituent and chemical species, solubilized or in suspension, are minor constituents.

Advantageously, the process of the invention makes it possible to apply on a coated membrane at least a deposit of a few micrometers of varnish in which silver has been dispersed or solubilized, and to cause it to adhere, while retaining the properties of said membrane, in particular its weldability.

Weldability is the ability of the coated and varnished membrane to be welded. The main welding methods of PVC coated membranes are hot air welding, high frequency welding, heat welding and ultrasonic welding. Advantageously, the varnish film according to the invention does not prevent the fusion of the two PVC layers of two different membranes and does not hinder their interpenetration.

Thus, advantageously, the varnish according to the invention adheres to the coated membrane and is resistant to abrasion, water, dirt and certain detergents. If necessary, the varnish according to the invention may be formulated so as to have a particular desired appearance (matt, glossy, etc.) or a particular resistance (such as UV resistance in the event of outdoor use of the membrane according to the invention), as explained below.

More specifically, the desired finish appearance (gloss, satin, matte) may be provided by adding an organic or inorganic matting agent, preferably selected from polymethyl urea or inorganic polymeric additives of the fumed silica type. A particular resistance such as, for example, a resistance to water and UV, may be brought by combining a polyurethane-type binder, preferably of the polycarbonate type, with anti-UV additives, preferably of the HALS type (for Hindered Amine Light Stabilizer, or amine-based stabilizer, such as the commercial products Tinuvin® NOR from BASF). The varnish may contain an additive of the polymeric or inorganic type, preferably of the polysiloxane type, in order to achieve the desired abrasion resistance.

According to the invention, silver is generally brought by the aqueous medium (solution or dispersion) which is generally of two kinds. In all cases, according to the invention, the maximum particle size is less than 250 nm in order to ensure the stability of the silver particles in solubilization or dispersion in water.

In the first case, silver is in the varnish in the form of a colloidal silver dispersion of particles of nanometric size less than 250 nm, preferably less than 150 nm, even more preferably less than 100 nm. In all these cases, the size is preferably greater than 1 nm. This size ensures optimal stability of the dispersions. There are several processes for producing such dispersions, described, for example, in the thesis of R. Chauvet mentioned above or in the thesis of A. Andrieux-Ledier “Elaboration of silver nanoparticles by reduction of metallo-organic salts: control of size, stability, organization and physical properties”, May 29, 2013, University P. and M. Curie Paris VI, HAL id tel-00827520.

This type of dispersion sold, for example, by HEIQ, which adds cholesterol-based vesicles thereto, under the commercial reference Viriblock® NPJ03. In this case, the silver content in the dispersion is generally in the range of 10 ppm to 10,000 ppm, preferably from 10 to 5,000 ppm, more preferably from 10 to 4,000 ppm.

Cerion also markets silver dispersions of particles of nanometric size (less than 10 nm).

Preferably, in this case, the polymeric binder has the same polarity as that of the aqueous medium containing the silver. For example, the binder will be cationic if the silver particles are provided by the commercial product Viroblock® NPJ03 from HEIQ. It can then be RU-13 537®, which is a cationic polyurethane polyether from Stahl, or RU-68002®, which is a cationic polyester polyurethane from Stahl, or Rolflex® C1, which is a cationic polyurethane polycarbonate from Lamberti.

In the second case, silver is in the varnish in the form of Ag⁺ ions solubilized in the varnish, preferably in the form of complexes solvated in water, even more preferably in the form of complexes soluble in water, generally selected from the group comprising silver nitrates AgNO₃, silver chlorides AgCl, and mixtures thereof.

In practice, the commercial products comprising these complexes are generally coupled with organic binders such as acrylate polymers. This makes it possible to use these products in direct textile impregnation without any other formulation as well as, advantageously, to stabilize the silver ions in the aqueous medium.

Thus, Sanitized markets the product Sanitized® T1115, which is a dispersion of silver nitrate at less than 0.5% by weight in the presence of an anionic acrylate binder at a pH in the range of 9.5 to 11.5.

Zschimmer and Schwarz markets the product Lefasol® MTV13002-1, which is an aqueous dispersion based on silver chloride and an anionic acrylate polymeric binder. The varnish generally also comprises at least one additive such as:
an adhesion promoter, for example a silane with epoxy function such as Deolink® TE 100 which is a 3-(2,3-epoxypropoxy)propyl]-triethoxysilane from DOG;
a spreading agent, for example a polysiloxane such as TEGO Glide® 482 which is a dimethylpolysiloxane from TEGO Evonik or Coatosil® 77, which is a trisiloxane from Momentive;
an antifoaming agent, for example a polysiloxane such as Byk® 1724 from BYK or Byk® 022, which is a polysiloxane from BYK; and
a slip agent, for example a polyethylene wax emulsion such as Joncryl Wax® 35 from BASF or TEGO Glide® 440, which is a siloxane and polyether copolymer from TEGO Evonik.

Preferably, the varnish additionally comprises an adhesion promoter, a spreading agent, an antifoaming agent and a slip agent.

Remarkably, it was possible to deposit the varnish aqueously on a layer of PVC comprising a plasticizer, according to the process of the invention. This presented many challenges for a person skilled in the art:
Spreading the varnish on the PVC: the high surface tension of the water makes aqueous varnishes very unsuitable for deposit on a PVC surface, resulting in a heterogeneous varnish film containing craters and protrusions. However, the varnish according to the invention advantageously has a homogeneous and smooth surface.
The cohesive force between the PVC substrate and the varnish had to be sufficient to anchor the varnish to the extreme surface of the PVC substrate.
The formation of foam, due to air captured during manufacture, had to be avoided so as not to generate any interference during the application of the varnish and create unwanted defects on the surface after the film has dried.
The surface should not be sticky.

According to a preferred embodiment, the varnish may also comprise at least one additional additive selected from UV stabilizers, heat stabilizers and pigments.

According to a third aspect, the invention relates to a use of a membrane according to the invention, or manufactured according to the process of the invention, as a virucide, generally in the field of technical textiles.

### BRIEF DESCRIPTION OF THE DRAWINGS

The way to implement the invention, as well as the advantages which result therefrom, emerge from the following description of the embodiments, in support of the appended FIGS. 1 to 4 in which:

FIG. 1 is a schematic sectional view of a first embodiment of the membrane of the invention.

FIG. 2 is an enlargement of FIG. 1.

FIG. 3 is a schematic sectional view of a second embodiment of the membrane of the invention.

FIG. 4 is an enlargement of FIG. 3.

Obviously, the dimensions and proportions of the elements illustrated in FIGS. 1 to 4 may have been exaggerated in relation to reality, and were given only for the purpose of making it easier to understand the invention.

### DETAILED DESCRIPTION OF THE INVENTION

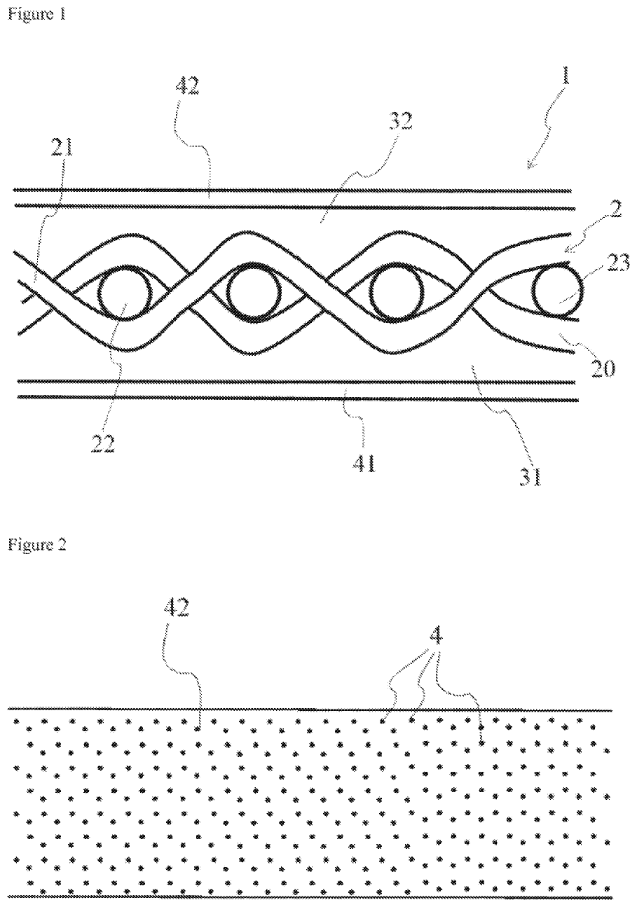

The coated and varnished membrane 1 of FIG. 1 comprises a core or textile reinforcement 2 consisting of a weaving in high tenacity polyethylene yarns, formed of warp yarns 22 intersecting with weft yarns 21 and 23. The woven core 2 was coated on both sides, 31 and 32, respectively, with a layer of PVC. According to the invention, two films of varnish, 41 and 42, respectively, were deposited on each coated side, the film 42 being enlarged in FIG. 2. The film 42 comprises silver 4, dispersed within the film 42.

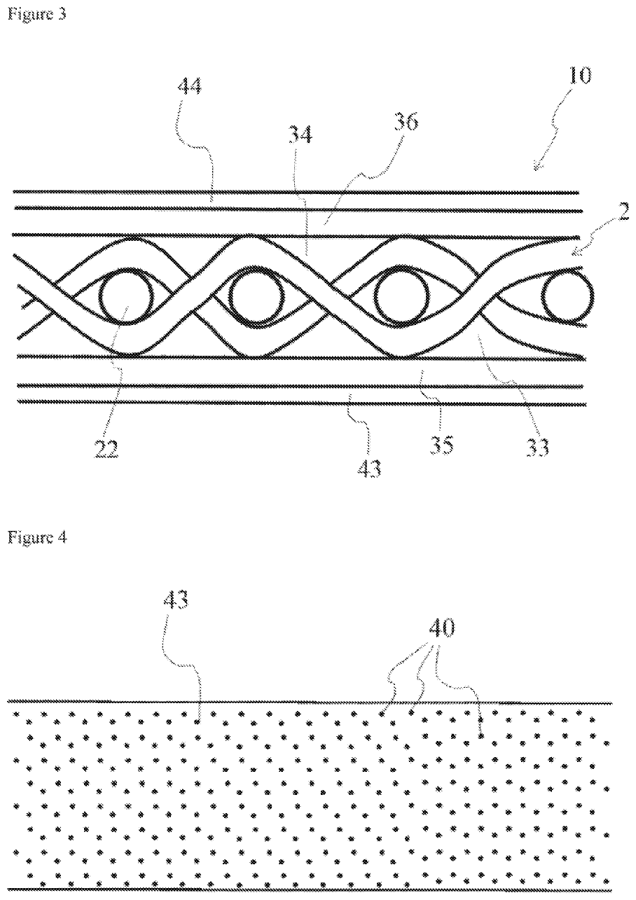

The coated and varnished membrane 10 of FIG. 3 comprises the same core or textile reinforcement 2. The woven core 2 was coated on both sides with two successive layers of PVC, 34 then 36, respectively, on one side, and 33 then 35 on the other side. According to the invention, two films of varnish, 44 and 43, respectively, were deposited on each coated side, the film 43 being enlarged in FIG. 4. The film 43 comprises silver 40 of nanometric size, dispersed within the film 43.

### EXAMPLES

Different tests were carried out on a same membrane coated with the same varnish film. To that end, an aqueous-phase varnish was deposited on a coated side of a membrane made from high tenacity polyester fabric coated with PVC on each side.

The silver used was a colloidal dispersion, the commercial product Viroblock® NR103 from HEIQ.

The varnish was manufactured 48 hours before its use and stored at a temperature above 5° C.

The varnish had the following composition (in parts by weight):
Binder: 63; Rolflex® C1 which is a cationic polyurethane polyester from Lamberti
Adhesion promoter: 1; Deolink® TE 100 which is a 3-(2,3-Epoxypropoxy)propyl]-triethoxysilane from DOG
Spreading agent: 1; TEGO Glide® 482 which is a dimethylpolysiloxane from TEGO Evonik
Antifoaming agent: 0.5; Bye 022 which is a polysiloxane from BYK
Slip agent: 0.1; TEGO Glide® 440 which is a siloxane and polyether copolymer from TEGO Evonik
Silver particles: 34.3; Viroblock® from HEIQ (6% dry extract in the film)

The preparation of the varnish was carried out as follows:

Stirring with a butterfly-shaped blade at low speed: 100-300 rpm;

Depositing the varnish by squeegee on a mat on the plastisol described above

Progressive drying with a temperature ramp of 110° C., then 130° C., then 150° C.; then Calendering at 150° C.

The thickness of the varnish once dried was on average 5 to 7 μm. It was checked by optical measurement on a microtome section of the slice of the membrane.

Action Test Against Viruses

Preliminary trials carried out to verify the feasibility of the test:
cell cytotoxicity indicator
membrane residual activity indicator

Controls made during the tests:
cell cytotoxicity indicator
membrane residual activity indicator
positive controls on 304 stainless steel disc

The virological analyzes are carried out by determining the infectious titers on MRCS cells (ATCC CCL-171) in limiting dilution. Cytopathogenic effects (CPE) readings are taken after 6 days of incubation at 37° C. and 5% CO₂.

The test was carried out compared to a reference coated membrane, i.e., a membrane that did not contain silver.

The human coronavirus HCoV-229E, which is part of the enveloped alpha coronas virus family, was used in the test.

The contact time between the membrane (comparative or according to the invention) and the solution containing the virus is 60 min.

Two environmental conditions were tested:
Cleanliness condition standardized in medical field: 0.3 g/l BSA
Complex interference condition: saliva and respiratory mucus.

50 to 100 μL of solution comprising the virus was deposited and the quantity of virus deposited was 10⁵ TCID50 (for 50% Tissue Culture Infectious Dose: titer required to cause infection in 50% of the inoculated cell cultures).

By comparison with the comparative membrane (without silver), the results were, for the coated and varnished membrane according to the invention, a reduction in the viral load of 99.9% at 60 min of contact, whether for the virus alone or for the virus with mucus and saliva.

Compliance was established for a value strictly greater than 90% after 1 hour of contact without mucus or saliva. Consequently, the tests demonstrated the antiviral function of the membrane according to the invention.

Test Demonstrating Weldability

Tests were carried out on an industrial high-frequency bench to verify that the varnish film did not prevent the fusion of two layers of PVC and did not interfere with their interpenetration during the welding of two membranes according to the invention. After this assembly by high frequency, the force required to open the weld was measured, according to the protocol described in the EN 15619 standard Appendix C.

The resulting value had to be equal to, or greater than, the value stated in the product datasheet, which is 9 daN over a width of 5 cm. The values measured were 11 daN/5 cm for the coated and varnished membrane according to the invention, against 10 daN/5 cm for the comparative membrane, thus validating the test for the two membranes.

Varnish Adhesion Test on the Coated Membrane

To check the good adhesion of the varnish film on the coated membrane, an ISO 5981 standard scrub fluxmeter test was carried out. This test applies strong movements to the membrane, capable of causing the varnish to peel off if the adhesion is too weak. After 2000 cycles of movement, scotch tape was applied to the coated and varnished membrane to verify that the varnish did not come off: the varnish remained on the membrane and did not come off at the same time as the tape. Adhesion was thus considered to be compliant for the membrane according to the invention, as well as for the comparative membrane.

Cleanability Tests of the Coated and Varnished Membrane According to the Invention.

The resistance to betadine and eosin stains of a coated and varnished membrane according to the invention was tested in accordance with the following procedure:
measuring the initial color of the fabric and recording it
taking a non-woven wipe as used in hospitals
impregnating it with betadine or eosin and rubbing it on the fabric. Leaving to “dry” for 10 min.
wiping with a clean dry wipe
measuring the Delta E (CMC) which quantifies the color evolution on the 2 types of stains
cleaning with high surface disinfectant detergent Anios (didecyldimethylammonium chloride and polyhexamethylene biguanide hydrochloride).
remeasuring the Delta E (CMC) after cleaning
   if Delta E (CMC) <2 excellent cleaning
   if Delta E (CMC) <5 good cleaning
   if Delta E (CMC) <7 average cleaning
   if Delta E (CMC) >7 poor cleaning

The membrane according to the invention made it possible to obtain results qualifying the cleaning as good, whether for betadine or for eosin.

Comparative Test Results

| | | | | Weldability | Coating |
|---|---|---|---|---|---|
| | % Ag | Anti- | | (greater | resistance |
| | in the | viral | Varnish | than 6 daN/ | to |
| | varnish | action | adhesion | 5 cm) | cleaning |
| Comparative | 0% | None | OK | 10 daN/5 cm | Good |
| membrane | | | | | |
| Membrane | 0.01% | >90% | OK | 11 daN/5 cm | Good |
| according | | reduction | | | |
| to the | | after 60 | | | |
| invention | | min of | | | |
| | | contact | | | |

“NOK” means that the test is not considered conclusive and OK means that the test is considered conclusive: the coated and varnished membrane according to the invention is compliant: the property was validated.

In conclusion, it was demonstrated that the coated and varnished membrane according to the invention has an antiviral action while retaining the desired properties of varnish adhesion, weldability and resistance to cleaning.

1. A coated and varnished membrane, said membrane comprising at least one fabric having at least one side coated with at least one layer of polyvinyl chloride, and at least one varnish film on said coated side of the membrane, said varnish film comprising a polymeric binder and silver in a form of a silver element less than 250 nm in size, said membrane being such that the varnish film has an average thickness comprised in a range of 0.5 to 20 μm and that a mass content of the silver in the varnish film is in a range of 0.00001 to 3%.

2. The membrane according to claim 1, wherein the fabric is selected from wovens, nonwovens, gris, knits, and mixtures thereof.

3. The membrane according to claim 1, wherein the fabric is made from textile material and comprises yarns or fibers made from a material selected from the group comprising glass, polyesters, polyamides, polyacrylates, viscoses, nylons, cottons and polyvinyl acetates, polyvinyl alcohols, and mixtures thereof.

4. The membrane according to claim 1, wherein the layer of polyvinyl chloride comprises polyvinyl chloride, at least one plasticizer and at least one heat stabilizer.

5. The membrane according to claim 1, wherein the average thickness of the varnish film is in a range of 1 to 12 μm.

6. The membrane according to claim 1, wherein the mass content of the silver in the varnish film is in the range of 0.0005 to 2%.

7. The membrane according to claim 1, wherein the polymeric binder is selected from the group comprising polyester polyurethanes, polyether polyurethanes, polycarbonate polyurethanes, silicone-modified polyurethanes, acrylics, acrylates, acrylate copolymers, acrylic copolymers, acrylic styrenes and ethylene vinyl acetates and mixtures thereof.

8. The membrane according to claim 1, wherein the varnish film further comprises at least one additive such as an adhesion promoter; a spreading agent; an anti-foaming agent; and a slip agent.

9. A process for manufacturing a membrane according to claim 1, comprising the following steps:
(a) providing a coated membrane comprising the at least one fabric coated on at least one side with the at least one layer of polyvinyl chloride;
(b) providing a varnish comprising an aqueous medium, at least one polymeric binder, and silver;
(c) depositing on the coated side from step (a) a film of the varnish from step (b), to a thickness in a range of 0.5 to 20 μm; and
(d) drying the varnish film from step (c), leading to a production of the coated and varnished membrane.

10. The process according to claim 9, wherein the silver is present in the varnish in a form of a dispersion of colloidal silver of particles of nanometric size less than 250 nm.

11. The process according to claim 9, wherein the silver is present in the varnish in a form of Ag⁺ ions solubilized in the varnish.

12. The membrane according to claim 1, said membrane being configured for use as a virucide.

13. The membrane according to claim 1, wherein the average thickness of the varnish film is in a range of 2 to 10 μm.

14. The membrane according to claim 1, wherein the mass content of silver in the varnish film is in a range of 0.001 to 1%.

15. The process according to claim 9, wherein the silver is present in the varnish in a form of a dispersion of colloidal silver of particles of nanometric size less than 150 nm.

16. The process according to claim 9, wherein the silver is present in the varnish in a form of a dispersion of colloidal silver of particles of nanometric size less than 100 nm.

17. The process according to claim 9, wherein the silver is present in the varnish in a form of soluble complexes.

18. The process according to claim 9, wherein the silver is present in the varnish in a form of complexes soluble in water selected from the group comprising silver nitrates AgNO₃, and silver chlorides AgCl, and mixtures thereof.
